(19) United States
(12) Patent Application Publication
(10) Pub. No.: US 2003/0076523 A1
(43) Pub. Date: Apr. 24, 2003

(54) Diagnosing method and diagnosing system of print picture quality of image processing apparatus

(76) Inventors: Akio Ito, Tokyo (JP); Masanori Yamada, Tokyo (JP); Yoichi Takaragi, Kanagawa (JP); Hideki Sakai, Chiba (JP); Masako Takahashi, Kanagawa (JP); Yoshiyuki Kojo, Kanagawa (JP); Masahito Yamamoto, Tokyo (JP); Yasushi Higuma, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/244,467

(22) Filed: Sep. 17, 2002

(30) Foreign Application Priority Data
Sep. 25, 2001 (JP) 290933/2001 (PAT.

(51) Int. Cl. G06F 3/12; G06F 11/30; G06F 15/00; H04N 1/00; G06K 15/02

(52) U.S. Cl. 358/1.14; 358/1.15; 710/15; 382/112; 358/406

(57) ABSTRACT

Print picture quality of an image processing apparatus is diagnosed, thereby enabling whether it is necessary to perform maintenance of the image processing apparatus or not to be monitored even from a remote location. For this purpose, a system for diagnosing the print picture quality of the image processing apparatus has: transfer means for transferring test data which is necessary for a test print from a server to the image processing apparatus; image input means for scanning an image which was print-outputted by the image processing apparatus in accordance with the test data and inputting image data; discriminating means for examining the image data and discriminating the print picture quality of the image processing apparatus; and notifying means for controlling whether the server is notified of the discrimination result in the discriminating means or not in accordance with this discrimination result.

### BACKGROUND OF THE INVENTION

1. Field of the Invention

The invention relates to a maintenance system in which when providing a maintenance service for performing maintenance to print picture quality of an image processing apparatus such as printer, copying apparatus, or the like, the print picture quality of the image processing apparatus is discriminated in accordance with an instruction from the user or periodically, and a maintenance center is notified on the basis of a discrimination result.

2. Related Background Art

Hitherto, a system such that a center server remotely monitors a status of an image processing apparatus such as copying apparatus, printer, or the like and, if an error occurs in the image processing apparatus, a serviceman is immediately sent away has existed. According to such a system, if a jam occurs in the image processing apparatus, consumables of the image processing apparatus are extinguished, or a printing mechanism portion of the image processing apparatus does not work, a controller of the image processing apparatus transmits error information to the center server. Thus, the center server analyzes the error information and recognizes an error status of the image processing apparatus.

### SUMMARY OF THE INVENTION

However, if the print picture quality of the image processing apparatus deteriorates, it is difficult for the image processing apparatus itself to detect it as an error. Among the users of the image processing apparatuses, there are the user who does not care slight deterioration of picture quality and the user who regards even slight deterioration of picture quality as a trouble.

The serviceman himself, therefore, needs to obtain printed matter outputted from the image processing apparatus and discriminate the print picture quality with the eyes. In order to provide a maintenance service of the print picture quality to image processing apparatuses installed at a plurality of locations, the serviceman needs to go to each location where the image processing apparatus has been installed.

Therefore, it takes a long time for the serviceman to check the print picture quality of each image processing apparatus. In order to compensate for it, it is necessary to prepare many servicemen, so that there is a risk of causing an increase in costs due to personnel costs.

It is, therefore, an object of the invention to provide a system in which print picture quality of an image processing apparatus is diagnosed even from a remote place and whether it is necessary to perform maintenance of the image processing apparatus or not can be monitored.

### BRIEF DESCRIPTION OF THE DRAWINGS

FIG. 1 is a diagram showing a construction of a picture quality maintenance system;

FIG. 2 is a diagram showing an outline of an image processing apparatus;

FIG. 3 is a block diagram showing a control construction of the image processing apparatus;

FIG. 4 is a diagram showing a functional construction of the picture quality maintenance system;

FIG. 5 is a diagram showing a table which is managed by a counter;

FIG. 6 which comprised of FIGS. 6A and 6B is a flowchart showing a process for discriminating print picture quality;

FIG. 7 which comprised of FIGS. 7A and 7B is a flowchart showing processes which are executed in the case where a result of a discrimination of the first time indicates the presence of a problem;

FIG. 8 is a flowchart showing a process for discriminating print picture quality;

FIG. 9 is a flowchart showing a process for testing whether a print position and a magnification are correct or not;

FIG. 10 is a diagram conceptually showing a state at the time when image data is being developed onto a memory space;

FIG. 11 is a flowchart showing a process for testing whether an oblique movement is correct or not;

FIG. 12 is a diagram showing examples of classification in the case where inclination degrees of an original and a lattice pattern are classified into a plurality of patterns;

FIG. 13 which comprised of FIGS. 13A and 13B is a flowchart showing a process for displaying a guidance of a diagnosing process of print picture quality;

FIG. 14 is a diagram showing a display example of a history of a diagnosis;

FIG. 15 is a diagram showing a construction of a picture quality maintenance system;

FIG. 16 is a diagram showing a construction of a picture quality maintenance system;

FIG. 17 is a diagram showing a construction of a picture quality maintenance system;

FIG. 18 is a diagram showing a memory map;

FIG. 19 is a diagram showing a memory map;

FIG. 20 is a diagram showing a memory map; and

FIG. 21 is a diagram showing a method of supplying program codes.

### DETAILED DESCRIPTION OF THE PREFERRED EMBODIMENTS

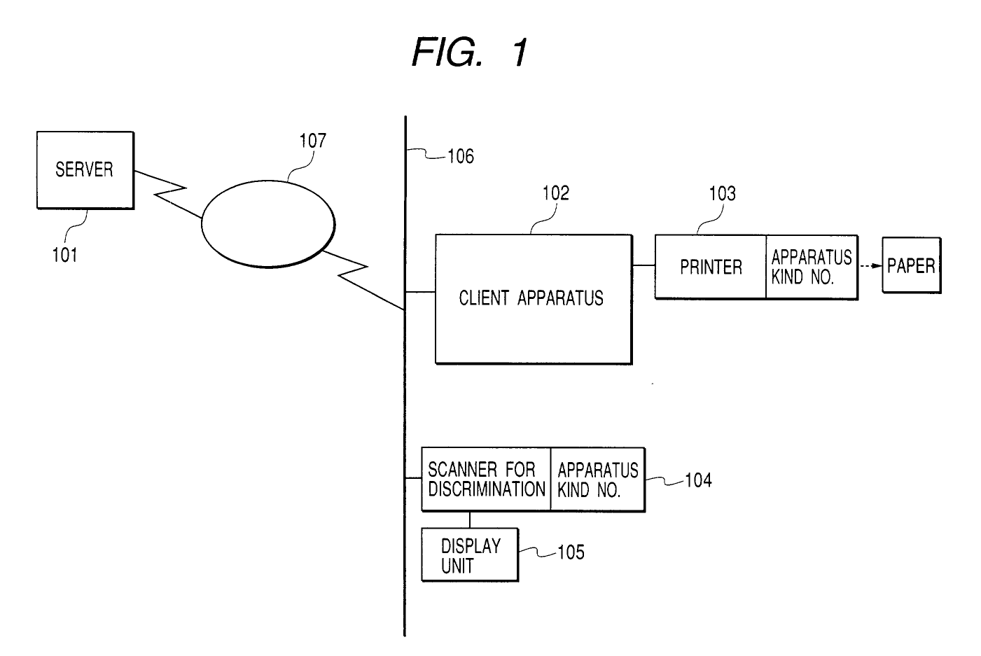

FIG. 1 is a diagram showing a construction of a system according to the invention, that is, a picture quality maintenance system for performing maintenance of print picture quality of a printer. A maintenance server 101 transfers necessary data to a client apparatus 102 when the maintenance of the picture quality is performed. The maintenance server 101 discriminates a state of the print picture quality of the printer on the basis of data from the client apparatus 102 or a scanner 104 for discrimination and manages it.

The client apparatus 102 is an apparatus to which a printer 103 is connected. The client apparatus 102 allows the printer 103 to execute a test print on the basis of test chart data sent from the maintenance server 101. In the client apparatus 102, the number of print sheets printed by the printer is managed by a counter or a status of the printer 103 is transmitted to the maintenance server 101, thereby integratedly managing the printer 103.

A copying apparatus, a laser beam printer, an ink jet printer, or a facsimile apparatus such that the printer 103 is arranged in the same casing can be also substituted for the client apparatus, or a host computer or a personal computer to/from which the printer 103 is detachable can be also substituted.

The printer 103 prints data onto recording paper on the basis of image data. The printer 103 has an apparatus kind number for specifying the printer itself and can transfer data indicative of the apparatus kind number in response to a request from the outside.

The scanner 104 for discrimination scans printed matter outputted by the printer 103, forms image data, and checks the print picture quality of the printer on the basis of the image data. As necessary, the scanner 104 transfers the formed image data to the maintenance server 101.

An LAN (Local Area Network) 106 is a network for connecting the client apparatus 102 and the scanner 104 for discrimination and usually corresponds to a network in an office or a predetermined site. A WAN (Wide Area Network) 107 is a wide area network to which a plurality of LANs are connected, that is, a network obtained by mutually connecting a plurality of networks by a public network, a dedicated line, or the like. Thus, computers existing at remote locations can mutually transmit and receive data.

The maintenance server 101 can be also connected to the LAN 106. However, by connecting the maintenance server 101 to a plurality of LANs via the WAN 107, for example, the maintenance service of the picture quality can be provided to a plurality of printers installed in a plurality of offices or a company.

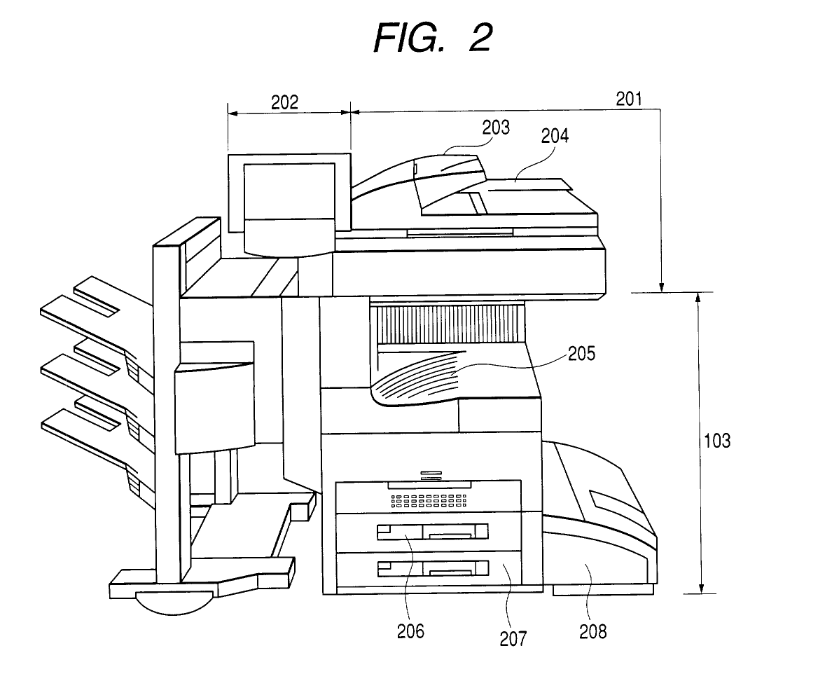

FIG. 2 is a diagram showing an external view of an image processing apparatus constructed by the client apparatus 102 and the printer 103. An example in which the client apparatus 102 is built in a copying apparatus will now be explained. A scanner 201 serving as an image input device illuminates an image on paper as an original and allows a CCD line sensor (not shown) to scan, thereby forming raster image data.

When the user sets the original paper onto a tray 203 of a document feeder 204 and instructs activation for reading via an operating unit 202, a controller CPU of the image processing apparatus issues an instruction to the scanner 201. The feeder 204 feeds the original paper one by one. The scanner 201 executes the reading operation of the original image.

The printer 103 as an image output device is a portion for printing the raster image data onto the paper. As a printing method, although there is an electrophotographic method using a photosensitive drum or a photosensitive belt, an ink jet method whereby ink is emitted from a micro nozzle array and an image is directly printed onto the paper, or the like, any method can be used. The printing operation is activated by an instruction from the controller CPU.

The printer 103 has a plurality of paper feeding stages so that different paper sizes or different paper directions can be selected and has sheet cassettes 206, 207, and 208 corresponding to them. A paper delivery tray 205 receives the paper delivered after completion of the printing.

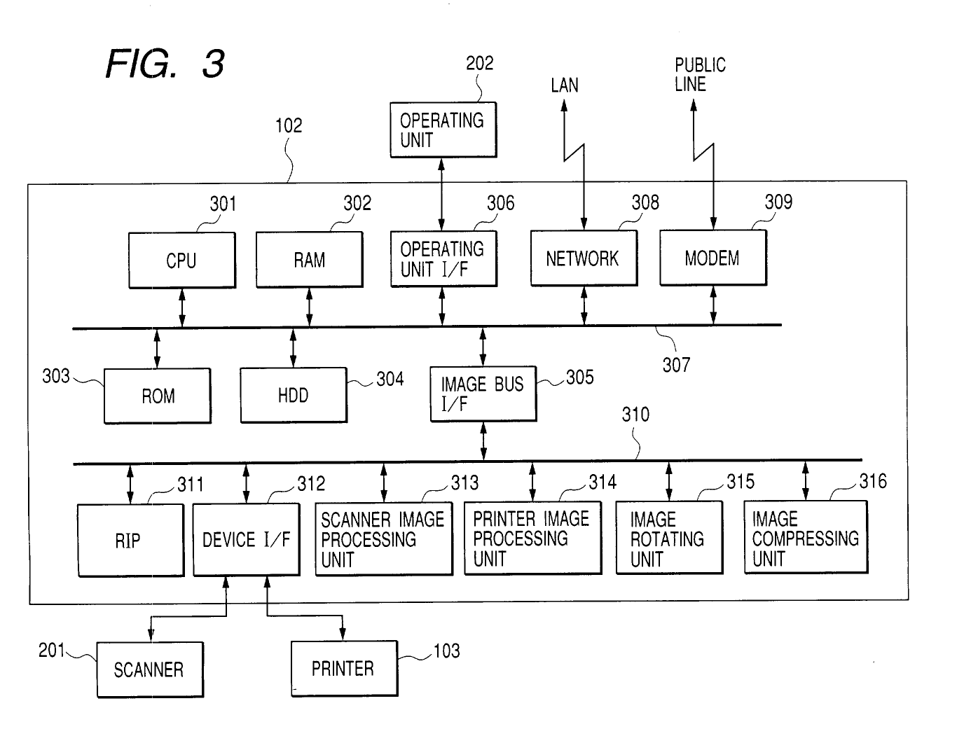

FIG. 3 is a block diagram showing a control construction of the image processing apparatus. The client apparatus 102 is a controller which is connected to the scanner 201 as an image input device and the printer 103 as an image output device and is further connected to the LAN or public line (WAN), thereby inputting and outputting image information or device information.

A CPU 301 is a controller for controlling the whole system. An RAM 302 is a system work memory which is used by the CPU 301 to operate. The RAM 302 is also an image memory for temporarily storing the image data. An ROM 303 is a boot ROM in which a boot program of the system has been stored. An HDD 304 is a hard disk drive for storing system software and the image data.

An operating unit I/F 306 is an interface with the operating unit (UI) 202 and outputs the image data to be displayed onto an operating unit 112 to the operating unit 112. The operating unit I/F 306 plays a role of transferring information inputted by the user via the operating unit 112 to the CPU 301.

A network (Network)308 is connected to the LAN 106 and inputs and outputs the information to/from the LAN 106. A modem (MODEM) 309 is connected to the public line and inputs and outputs the information to/from the public line. The above-mentioned devices are arranged onto a system bus 307.

An image bus interface (Image Bus I/F) 305 is a bus bridge which connects the system bus 307 to an image bus 310 which transfers the image data at a high speed and converts a data structure. The image bus 310 is constructed by a PCI bus or IEEE1394.

The following devices are arranged onto the image bus 310. A raster image processor (RIP) 311 develops a PDL code transmitted from the network into a bit map image. A device I/F unit 312 connects the scanner 201 and printer 103 as image input/output devices to a control unit 111 and executes conversion of a synchronous system/asynchronous system of the image data.

A scanner image processing unit 313 executes correction, modification, and edition to the input image data. A printer image processing unit 314 executes correction, resolution conversion, and the like of the printer to the print output image data. An image rotating unit 315 rotates the image data. An image compressing unit 316 executes a JPEG compressing/decompressing process to multivalue image data and executes a compressing/decompressing process of JBIG, MMR, or MH to binary image data.

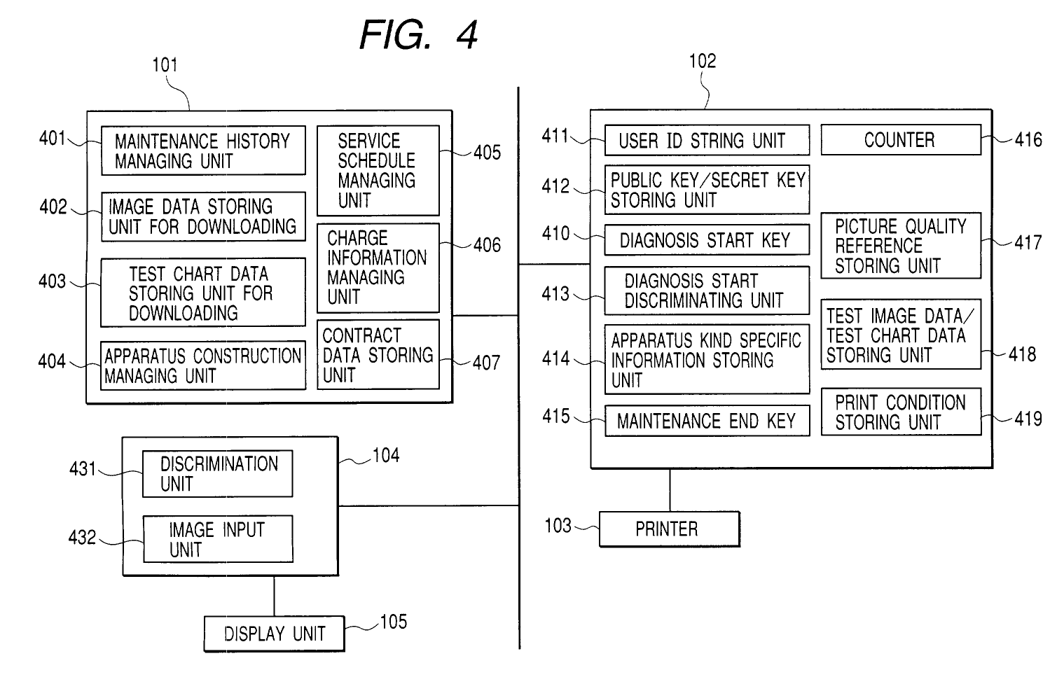

FIG. 4 is a diagram showing a functional construction of the picture quality maintenance system. Reference numerals 401 to 407 denote functional component elements of the maintenance server 101. Reference numerals 410 to 419 denote functional component elements of the client apparatus 102. Reference numerals 431 and 432 denote functional component elements of the scanner 104 for discrimination.

A maintenance history managing unit 401 manages a history of the executed maintenance. In the history, date/time when print picture quality is discriminated, a result of the discrimination of the print picture quality, the image data read out by the scanner 104 for discrimination when the print picture quality is discriminated, a kind of maintenance which was executed, and the like are recorded every apparatus kind number of the printer.

An image data storing unit for downloading 402 stores image data for test which is used when a test print is executed. When a test chart is executed, the image data is transferred from the image data storing unit 402 to the client apparatus 102.

Data which is necessary when the test chart is executed has been stored in a test chart data storing unit for downloading 403. The test print is executed by printing the image data for test on the basis of an instruction by the test chart data.

An apparatus construction managing unit 404 manages information showing a construction of an apparatus as a target of maintenance. For example, information indicative of the apparatus kind number, the presence or absence of an option, a network address (IP address), an owner, an installing location, and the like is managed every apparatus by using a database.

A service schedule managing unit 405 forms a schedule for sending the serviceman away in accordance with contract contents shown by data stored in a contract data storing unit, and issues an instruction to the serviceman in accordance with the schedule. For example, the serviceman is arranged so that the serviceman can be immediately sent away to the printer which made a contract such that maintenance of high quality is provided.

A charge information managing unit 406 calculates a maintenance charge for the printer on the basis of a count value of a counter of the printer and stores it.

A contract data storing unit 407 stores data indicative of contract contents showing what kind of picture quality maintenance is provided. A level of the print picture quality at which the serviceman should be sent away to thereby execute the maintenance, extension time (days) which is permitted from timing when the print picture quality has been discriminated until timing when the serviceman is sent away, and the like are shown in the contract contents.

An ID to identify the owner of the printer 103 has been stored in a user ID storing unit 411. A providing destination which provides the service of the picture quality maintenance is specified by using the ID. A public key/secret key storing unit 412 stores a public key, a secret key, and the like which are necessary for encrypting transfer data at the time when the data is transferred to the server 101.

A diagnosis start key 410 is a button which is used for the user to instruct so as to discriminate the print picture quality. When the diagnosis start key 410 is pressed, the client apparatus 102 executes the test print, or the client apparatus 102 periodically executes the test print.

A diagnosis start discriminating unit 413 discriminates whether the diagnosis of the print picture quality is executed or not. If a mode of periodically executing the diagnosis has been set, it is determined that the diagnosis is executed at every set period of time. If a mode of executing the diagnosis when the diagnosis start key is pressed has been set, whether the diagnosis start key 410 has been pressed or not is monitored, and it is determined that the diagnosis is executed in response to the depression of the diagnosis start key.

An apparatus kind specific information storing unit 414 stores information for identify the printer 103, for example, the apparatus kind number of the printer 103.

A maintenance end key 415 is a button which is pressed when the serviceman finishes the maintenance. When the maintenance end key 415 is pressed, the server 101 is notified of this fact. The maintenance history managing unit 401 stores the completion of the maintenance.

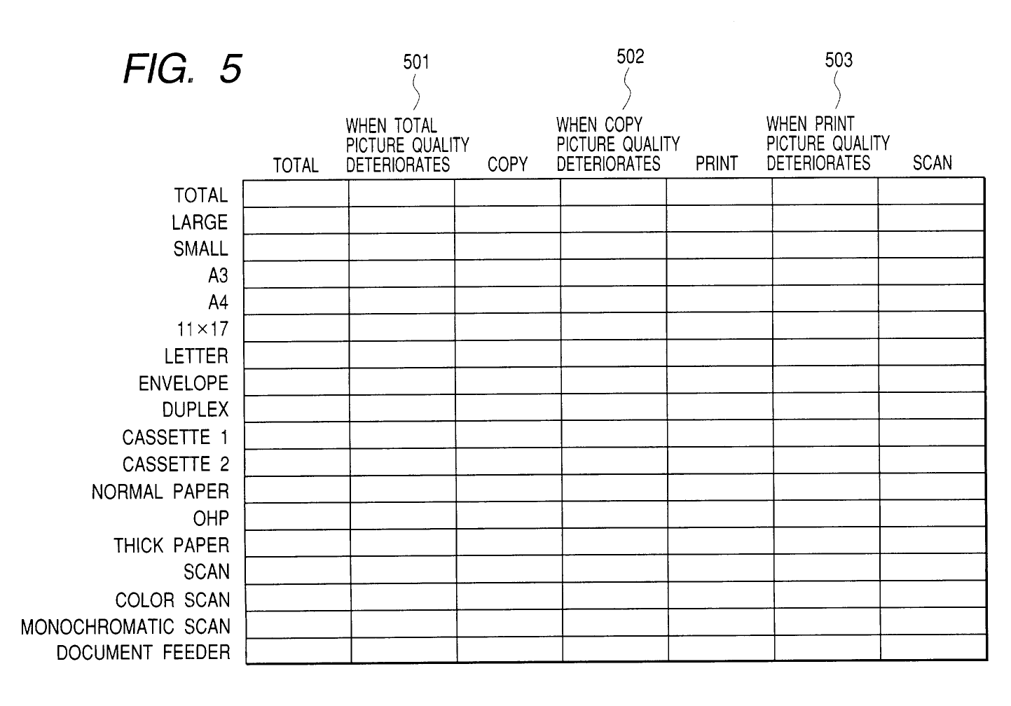

A counter 416 counts the number of print sheets printed by the printer 103. The number of print sheets is counted every kind of paper, every print by copy, or every print by a printing request from a host computer. FIG. 5 is a diagram showing a table which is managed by the counter 416. The number of sheets printed in total, the number of sheets printed by the copy, and the number of sheets printed by the printing request from the host computer have been stored in the table every kind of paper arranged in the portrait direction.

If deterioration in picture quality is recognized by the discrimination of the print picture quality, the number of print sheets is separately counted. That is, within a period of time from the timing when the deterioration in picture quality is recognized until the timing when the maintenance corresponding thereto is finished, the number of sheets printed in total is stored into a memory area 501, the number of sheets printed by the copy is stored into a memory area 502, and the number of sheets printed by the printing request is stored into a memory area 503, respectively.

In the discrimination of the print picture quality, information showing a degree of the discrimination result about “OK” (no problem) or “NG” (there is a problem) has been stored in a picture quality reference storing unit 417. For example, information indicative of a permission range of resolution or color deviation at the time when the discrimination result is determined to be OK (or NG) is stored.

The image data for test and test chart data transferred from the server 101 are stored in a test image data/test chart data storing unit 418. Since important know-how of a company which provides the picture quality maintenance service has been stored in those data, if it is shared and used by various persons, it is unpreferable for the service provider. Therefore, the test image data and test chart data stored in the storing unit 418 are deleted after completion of the diagnosis of the print picture quality.

A print condition storing unit 419 stores information showing print conditions which are required by the user (or the owner) of the printer 103. For example, if the user requires the print of high quality, a print condition such as “print of high quality” is set. If the print of high quality only for a color print is required, print conditions such as “color print of high quality, standard monochromatic print” are set. The desired print conditions of the user are inputted from the operating unit 202 of the client apparatus 102 and stored into the print condition storing unit 419. The information showing the degree which is stored into the picture quality reference storing unit 417 is determined on the basis of the information stored in the print condition storing unit 419.

An image input unit 432 scans the printed matter outputted by the test print and inputs image data. A discrimination unit 431 discriminates quality of the inputted image data by collating with the degree shown by the information stored in the picture quality reference storing unit 417. The server 101 is notified of a discrimination result as necessary.

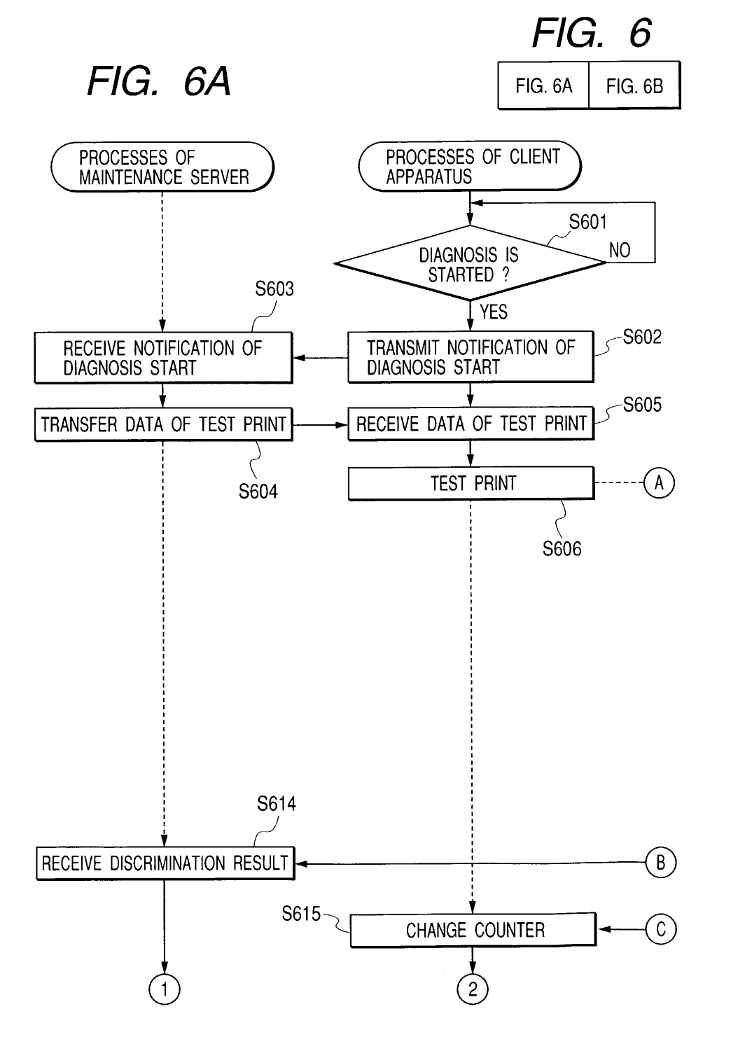

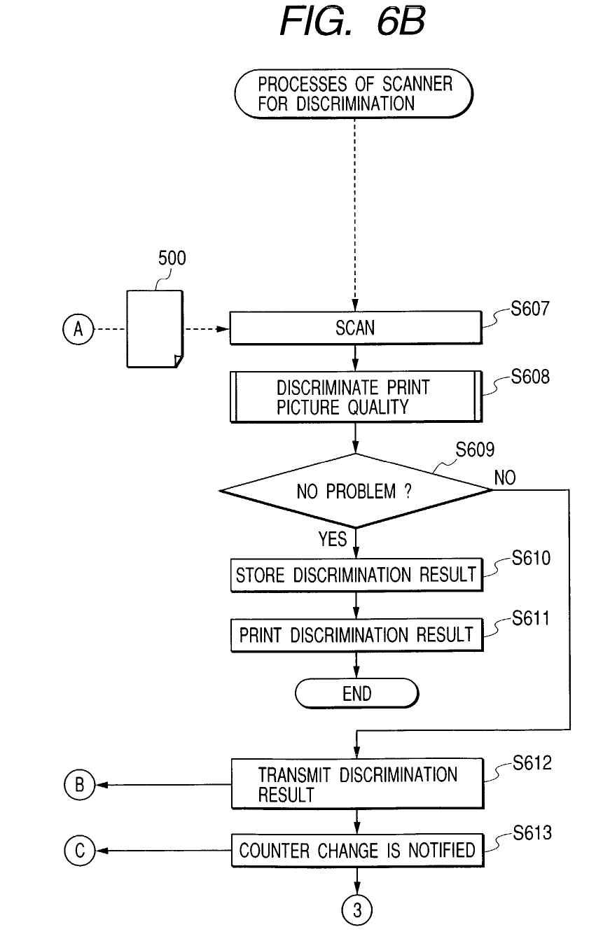

FIGS. 6A and 6B are flowcharts showing the process for discriminating the print picture quality. Steps S603, S604, and S614 are executed by the maintenance server. Steps S601, S602, S605, S606, and S615 are executed by the client apparatus. Steps S607 to S613 are executed by the scanner for discrimination. Those processes are executed by a method whereby the program codes corresponding to each processing step are executed by the CPU of the apparatus.

First, in step S601, the diagnosis start discriminating unit 413 discriminates whether the diagnosis is started or not. When the diagnosis start key 410 is pressed by the user, the diagnosis start discriminating unit 413 determines that the diagnosis is started. If the mode to periodically execute the diagnosis has been set, it is determined that the diagnosis is started after the elapse of the set time or period. If it is determined that the diagnosis is not started, the processing routine is returned to step S601. If it is determined that the diagnosis is started, the processing routine advances to step S602.

In step S602, the maintenance server 101 is notified of the fact that the diagnosis is started. Upon notification, the maintenance server 101 is also notified of the ID information stored in the user ID storing unit 411, the information showing the apparatus kind number stored in the apparatus kind specific information storing unit 414, the information showing the print conditions stored in the print condition storing unit 419, and the like.

In step S603, the maintenance server 101 receives the notification of the start of the diagnosis. In step S604, subsequently, the image data for test stored in the image data storing unit 402 for downloading and the test chart data stored in the test chart data storing unit 403 for downloading are transmitted to the client apparatus 102. At this time, it is assumed that data for discriminating whether the desired print conditions are satisfied or not on the basis of the information showing the print conditions transmitted from the client apparatus 102 is transmitted.

Subsequently, in step S605, the client apparatus 102 receives data necessary for test print. In step S606, the image data for test is transferred to the printer 103, thereby allowing the printer 103 to execute the test print. The image data for test is the data based on the know-how for keeping the print picture quality of the printer. Therefore, if the image data for test is used at the discretion of a third party, it is troublesome for the person who provides the maintenance service. To avoid such a situation, the client apparatus 102 detects the completion of the test print and erases the image data for test.

However, if the image data for test is transferred every time from the maintenance server 101 to the client apparatus 102, a communication load increases. Therefore, it is also possible to enable the printer 103 to hold those data. In such a case, an instruction showing that the data held by the printer is used is transmitted from the maintenance server 101 to the client apparatus 102 and, further, transmitted from the client apparatus 102 to the printer 103. Thus, the printer 103 executes the test print by using the held image data for test. In this case, the printer 103 encrypts the image data for test and holds it so that the image data for test is not illegally used by the third party.

After that, the user brings outputted paper 600 to the scanner 104 for discrimination and sets the paper 600. Thus, in step S607, the scanner 104 for discrimination scans the original (paper 600) and inputs the image data.

Subsequently, in step S608, the print picture quality of the printer 103 is discriminated on the basis of the inputted image data. The discriminating process of the print picture quality will be explained hereinlater. If a discrimination result indicates “no problem”, the discrimination result is stored in a discrimination result storing unit in step S610. The discrimination result storing unit is constructed by a non-volatile memory such as an HDD or the like. If the discrimination result storing unit is provided for the client apparatus 102, the scanner 104 for discrimination transmits the discrimination result and its storing request to the client apparatus 102.

If there is no problem, there is no need to immediately notify the maintenance server 101 of the discrimination result. Therefore, a plurality of discrimination results are transferred in the lump to the maintenance server 101 periodically, for example, once a day or once a few days. By this method, communication with the maintenance server 101 can be reduced as much as possible.

In step S611, in order to notify the user of the discrimination result, print data indicative of the discrimination result is formed and transferred to the printer 103, thereby allowing the printer to print the discrimination result. Thus, the user can be notified of the discrimination result. As contents to be printed, in addition to the discrimination result, there are a data name of the image data for test, date/time, an apparatus kind number of the printer 103, a discriminating method, an operating mode, a version of a test chart, temperature and humidity at that time, and the like. In place of printing the discrimination result, the discrimination result can be also displayed onto a display unit 105.

In this instance, it is assumed that the discrimination result is set to three stages: that is, A “no problem”, B “there is a problem (attention is required)”, and C “there is a problem (maintenance is necessary)”.

If there is a problem in the discrimination result (NO in step S609), the discrimination result is transmitted to the maintenance server 101 in step S612. At this time, the scanner 104 for discrimination transmits print causes, the inputted image data, the name of the image data for test, the date/time, the apparatus kind number of the printer 103, the discriminating method, and the like to the maintenance server 101. Thus, the maintenance server 101 receives the discrimination result in step S614. Although the discrimination result is transmitted to the maintenance server 101 when the discrimination result indicates B or C here, for example, the discrimination result can be also transmitted only when the discrimination result indicates C in accordance with the print conditions or the contract contents. In this case, it is assumed that the information showing the contract contents has been stored as a picture quality reference in the picture quality reference storing unit.

The scanner 104 for discrimination instructs the client apparatus 102 to change the counter in step S613. Thus, the client apparatus 102 executes a changing process of the counter in step S615. That is, if there is a copy or a printing request from the host computer after that, the values in the areas 501, 502, and 503 in FIG. 5 are counted up (updated).

By this method, a process such that the copy or printing request is perfectly inhibited because there is a problem in the print picture quality is not executed, but it is possible to construct the system in a manner such that the copy or printing request which is executed during a period of time when there is a problem in the print picture quality is charged at low costs, so that satisfaction of the user is obtained.

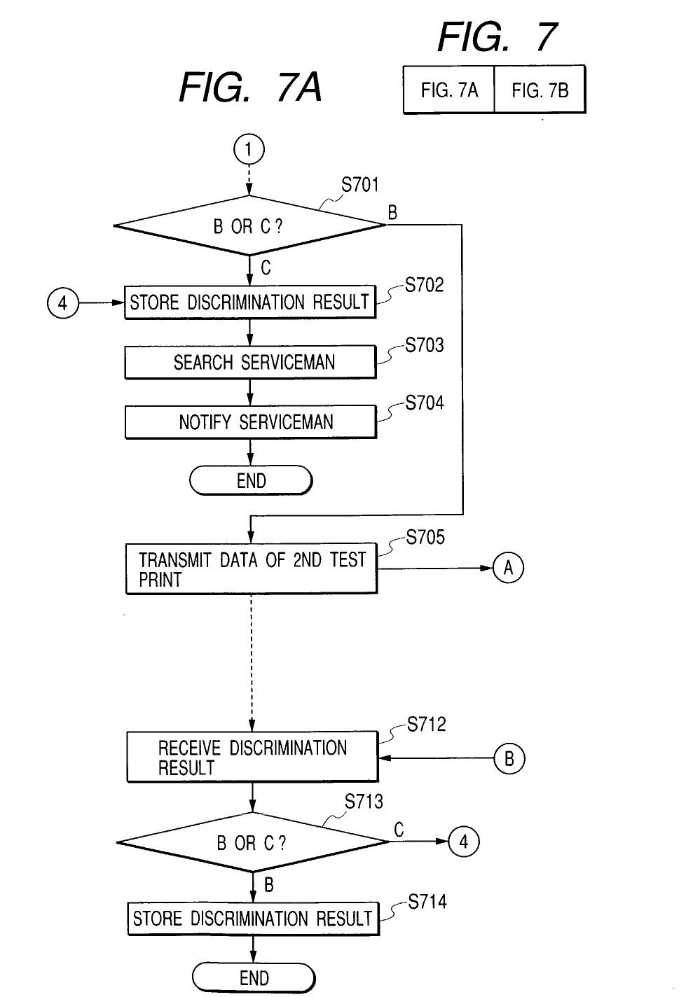

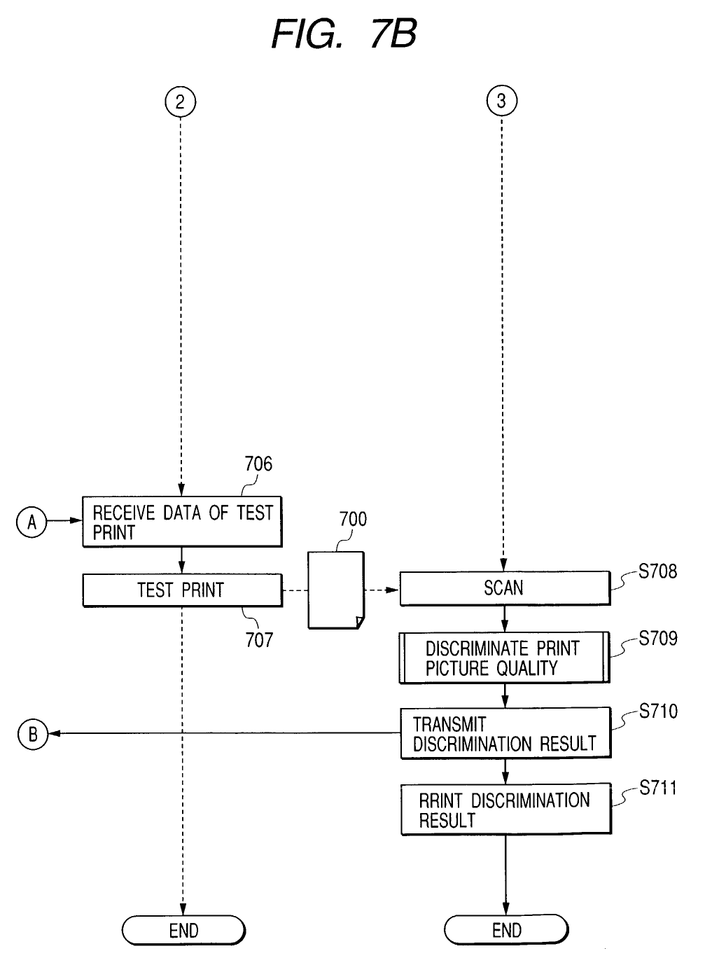

FIGS. 7A and 7B are flowcharts showing processes which are executed in the case where the result of the discrimination of the first time indicates the presence of the problem. Steps S701 to S705 and S712 to S714 are executed by the maintenance server 101. Steps S706 and S707 are executed by the client apparatus 102. Steps S708 to S711 are executed by the scanner 104 for discrimination. Those processes are executed by a method whereby the program codes corresponding to each processing step are executed by the CPU of the apparatus.

First, in step S701, whether the discrimination result received in step S614 indicates B or C is discriminated. If the discrimination result indicates B, step S705 follows. If the discrimination result indicates C, step S702 follows.

If the discrimination result indicates C, since it is necessary to immediately perform the maintenance, the serviceman is sent away in the following steps. First, in step S702, the maintenance history managing unit 401 stores the discrimination result. Subsequently, the service schedule managing unit 405 determines the serviceman to be sent away and the maintenance date on the basis of a schedule table of each serviceman and the installing location of the printer 103.

In step S704, E-mail is displayed onto a cellular phone of the determined serviceman so that he goes to the installing location of the printer to thereby perform the maintenance. At this time, the information showing the discrimination result, the image data inputted by the scanner 104 for discrimination, the user ID, the apparatus kind number of the printer 103, the installing location of the printer 103, and the like is also transmitted by E-mail to the cellular phone.

If the discrimination result indicates B (if it is determined to be B in step S701), the diagnosis of the second time is executed in order to confirm whether the maintenance is really unnecessary. Therefore, in order to perform the second test print, the second image data for test and the second test chart data are transmitted to the client apparatus 102 in step S706. At this time, data to examine portions, in detail, which could not be discriminated in the test print of the first time is transmitted.

In next step S706, the client apparatus 102 receives the data necessary for test print. In step S707, the image data for test is transferred to the printer 103, thereby allowing the printer 103 to execute the test print.

After that, the user brings outputted paper 700 to the scanner 104 for discrimination and sets the paper 700. Thus, in step S708, the scanner 104 for discrimination scans the original (paper 700) and inputs the image data.

Subsequently, in step S709, the print picture quality of the printer 103 is discriminated on the basis of the inputted image data. The discrimination result and causes are transmitted to the maintenance server 101 in step S710. At this time, the discrimination result is stored in the discrimination result storing unit. If the discrimination result storing unit is provided for the client apparatus 102, the scanner 104 for discrimination transmits the discrimination result and its storing request to the client apparatus 102.

In step S712, the maintenance server 101 receives the discrimination result. In step S713, whether the received discrimination result indicates B or C is discriminated. If it indicates C, it is determined that the maintenance is necessary and step S702 follows. If it indicates B, it is determined that the maintenance is unnecessary yet at this time as a result of detailed examination. In step S714, therefore, the maintenance history managing unit 401 merely stores the discrimination result, and the processing routine is finished.

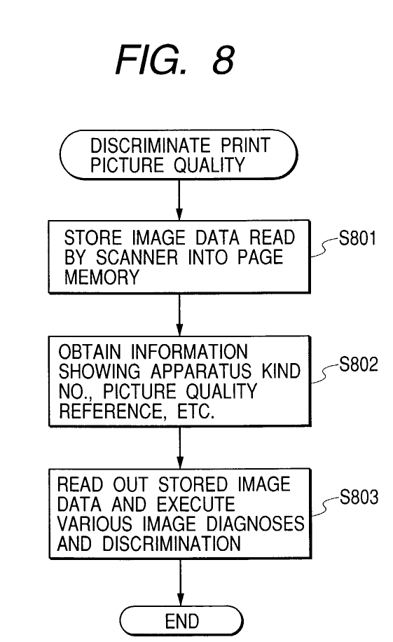

FIG. 8 is a flowchart showing the process for discriminating print picture quality which is executed in step S608 or S709. This process is executed by the discrimination unit 431 in the scanner 104 for discrimination. First, in step S801, the read image data is stored into a page memory. In step S802, a request is issued to the client apparatus 102 and the information indicative of the apparatus kind number of the printer 103, the information showing an image reference, and the like are obtained from the client apparatus 102. At this time, the test chart data transmitted from the maintenance server 101 is also obtained.

In step S803, the image data stored in the page memory is read out and various image diagnoses and discrimination are executed. At this time, the image data is tested in accordance with a test chart shown by the test chart data and collated with the set picture quality reference, thereby calculating the discrimination result. The print position, magnification, and oblique movement are tested here.

The test chart data is the data based on the know-how for keeping the print picture quality of the printer. Therefore, if the image data for test is used at the discretion of a third party, it is troublesome for the person who provides the maintenance service. To avoid such a situation, the scanner 104 for discrimination detects the completion of the discriminating process and erases the test chart data.

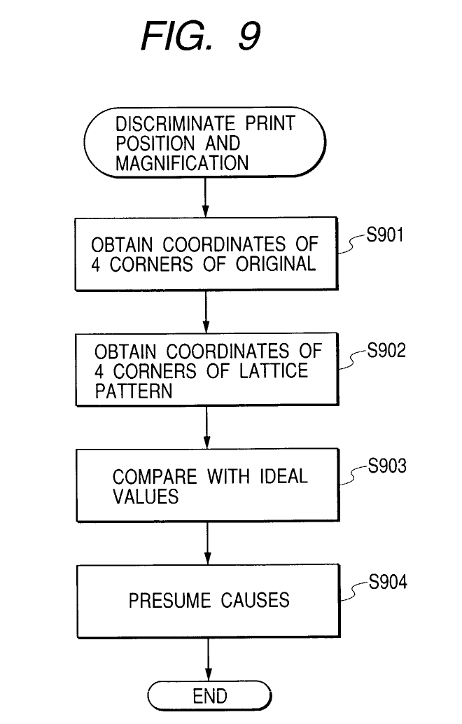

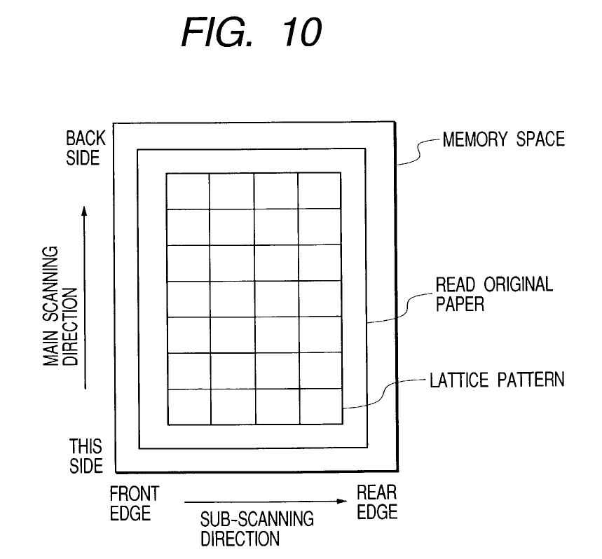

FIG. 9 is a flowchart showing a process for testing whether the print position and the magnification are correct or not. In order to perform the test, a lattice pattern has been test-printed at a predetermined magnification. FIG. 10 is a diagram conceptually showing a state at the time when the image data inputted by the scanner 104 for discrimination is being developed onto a memory space. The original paper and the lattice pattern are expressed by data in the memory space.

Therefore, first, in step S901, coordinates of four corners of the original are obtained from the read-out image data. Subsequently, in step S902, coordinates of four corners of an outer frame of the lattice pattern are obtained. In step S903, the coordinates of the four corners of the original are compared with the coordinates of the four corners of the outer frame of the lattice pattern, thereby calculating the print positions of the four corners of the lattice pattern and the magnification, and further, the print positions and the magnification are compared with ideal values. It is assumed that the ideal values have been disclosed in the test chart data.

In step S904, a discrimination is made on the basis of comparison results in step S903. If there is a problem, its causes are presumed. If the magnification and the print positions lie within a range of predetermined precision, they are determined to be normal. If the magnification lies within the predetermined precision range and the print positions are defective, it is presumed that print writing timing is defective. If the magnification is defective and a print start position lies within a predetermined precision range, it is presumed that a speed of a transfer drum of the printer 103 or copy paper are defective. If both of the magnification and the print positions are defective, it is presumed that both of the above two items are defective.

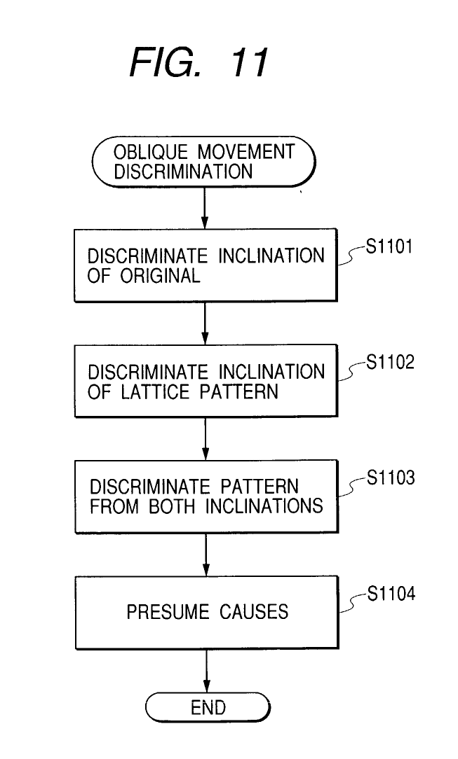

FIG. 11 is a flowchart showing a process for testing whether the oblique movement is correct or not. First, in step S1101, an inclination of the original is calculated from the read-out image data. Subsequently, an inclination of the lattice pattern is calculated. The inclination of the original is compared with the inclination of the lattice pattern, thereby discriminating to which one of patterns A to E in FIG. 12 the lattice pattern corresponds. FIG. 12 is a diagram showing examples of classification in the case where inclination degrees of the original and the lattice pattern are classified into a plurality of patterns.

In step S1104, discrimination is made on the basis of a comparison result in step S1103. If there is a problem, its causes are presumed. If the lattice pattern corresponds to the pattern A, it is determined to be normal. If the lattice pattern corresponds to the pattern B, it is determined that the paper has obliquely been moved to this side during the transfer of the image onto the paper. If the lattice pattern corresponds to the pattern C, it is determined that the paper has obliquely been moved to back side during the transfer. If the lattice pattern corresponds to the pattern D, it is determined that the back side of the paper has been moved first before the transfer. If the lattice pattern corresponds to the pattern E, it is determined that this side of the paper has been moved first before the transfer.

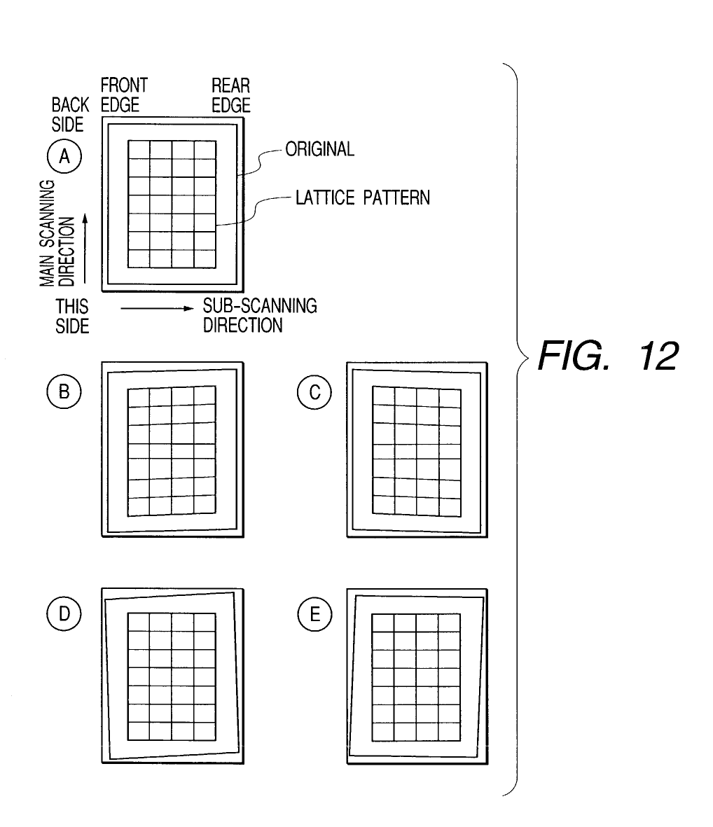

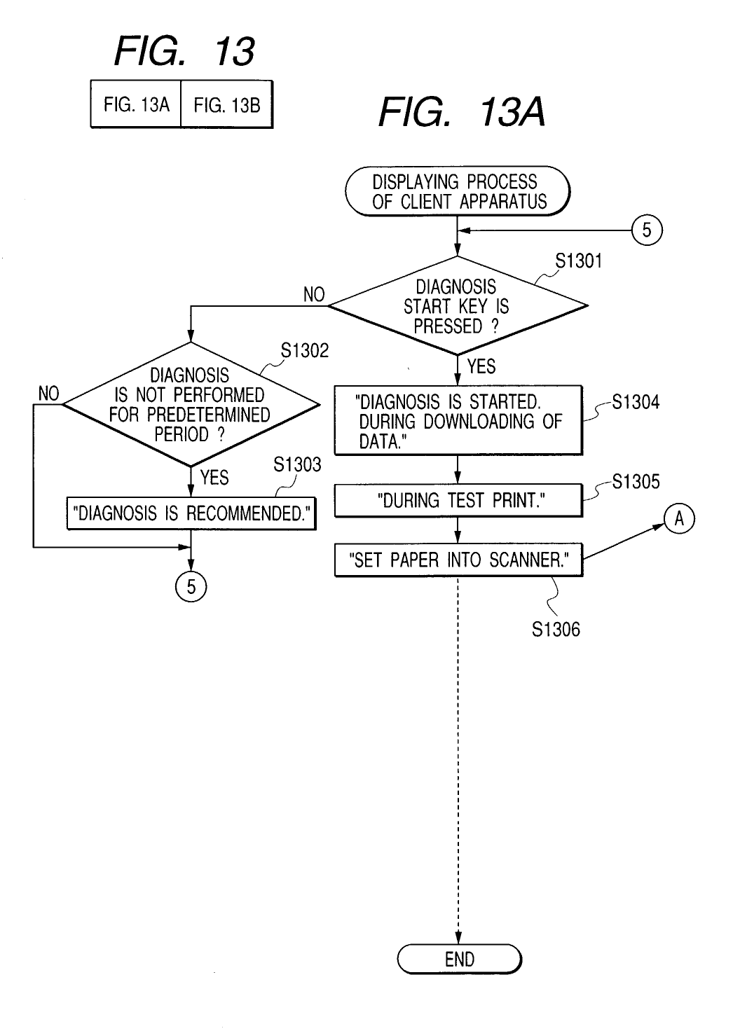

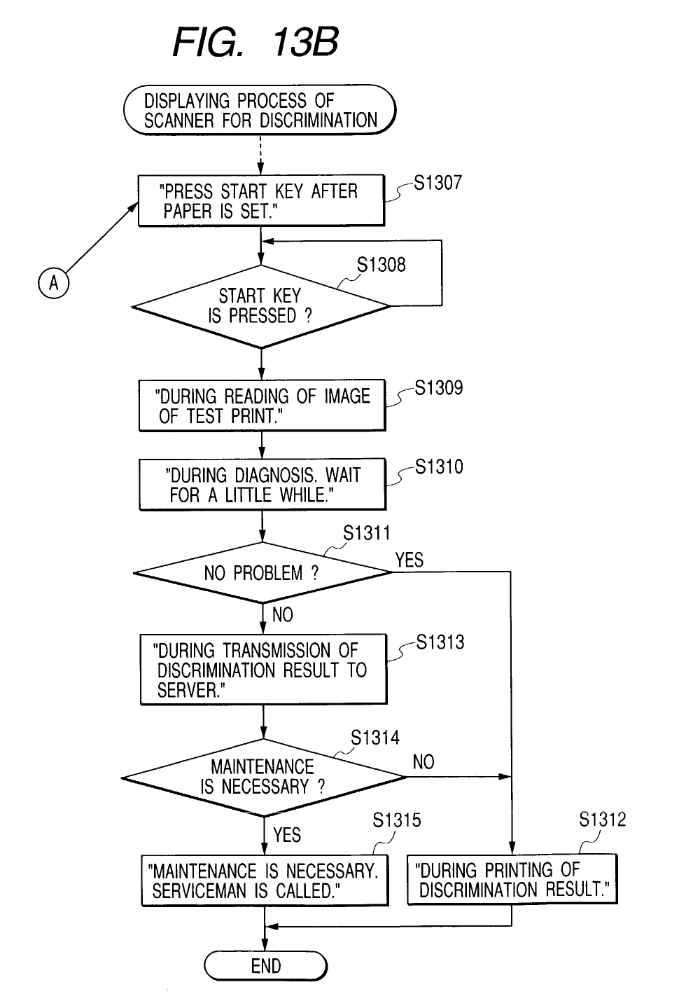

FIGS. 13A and 13B are flowcharts showing a process for displaying a guidance to the operating unit 202 of the client apparatus 102 and to the display unit 105 of the scanner 104 for discrimination in case of discriminating the print picture quality. Steps S1301 to S1306 are executed by the client apparatus 102. The message is displayed onto the operating unit 202. Steps S1307 to S1315 are executed by the scanner 104 for discrimination and the message is displayed to the display unit 105. This process is executed by a method whereby the program codes corresponding to each processing step are executed by the CPU of the apparatus.

First, in step S1301, whether the diagnosis start key has been pressed or not is discriminated. If the diagnosis start key has been pressed, step S1304 follows. If it is not pressed, step S1302 follows.

In step S1302, whether a predetermined period has elapsed after the diagnosis was finally performed or not is discriminated. If the diagnosis is not performed for the predetermined period, a message “Diagnosis is recommended.” is displayed in step S1303.

If the diagnosis start key has been pressed (YES in step S1301), a message “Diagnosis is started. During downloading of data.” is displayed in step S1304. At this time, the processes in steps S602 to S605 are executed.

If all of the data of the test print has been received and the test print is started, a message “During test print.” is displayed in step S1305. When the test print is completed, a message “Set paper into scanner.” is displayed in step S1306. Thus, the user brings the paper to the scanner.

The scanner 104 for discrimination displays a message “Press start key after paper is set.” in step S1307. In step S1308, the apparatus waits for depression of the start key.

When the start key is pressed by the user, a message “During reading of image of test print.” is displayed in step S1309. At this time, the process in step S608 is executed. If “no problem” as a result of the discrimination, step S1312 follows. If “there is a problem”, step S1313 follows.

If “no problem”, since the discrimination result is printed out, a message “During printing of discrimination result.” is displayed in step S1312. At this time, the discrimination result can be displayed to the operating unit 202 of the client apparatus and to the display unit 105 of the scanner 104 for discrimination. In this case, a message “There is no problem in print picture quality in printer 103.” is displayed.

If there is a problem, since the discrimination result is transmitted to the maintenance server 101, a message “During transmission of discrimination result to server.” is displayed in step S1313. After that, whether the maintenance is necessary or not is discriminated. If the maintenance is necessary, a notification of this fact is received from the maintenance server 101.

If the maintenance is unnecessary, step S1312 follows. If the maintenance is necessary, since the maintenance server 101 executes a process for sending the serviceman away, a message “Maintenance is necessary. Serviceman is called.” is displayed in step S1315.

By the processes in FIGS. 13A and 13B, the user can grasp a degree of progress of the discriminating process of the print picture quality. Particularly, it is possible to enable the user to grasp the fact that the copy cannot be used due to the downloading of the data necessary for the test print or the test print. It is also possible to teach the user so that he can easily understand the operation for setting the printed matter outputted by the test print into the scanner for discrimination.

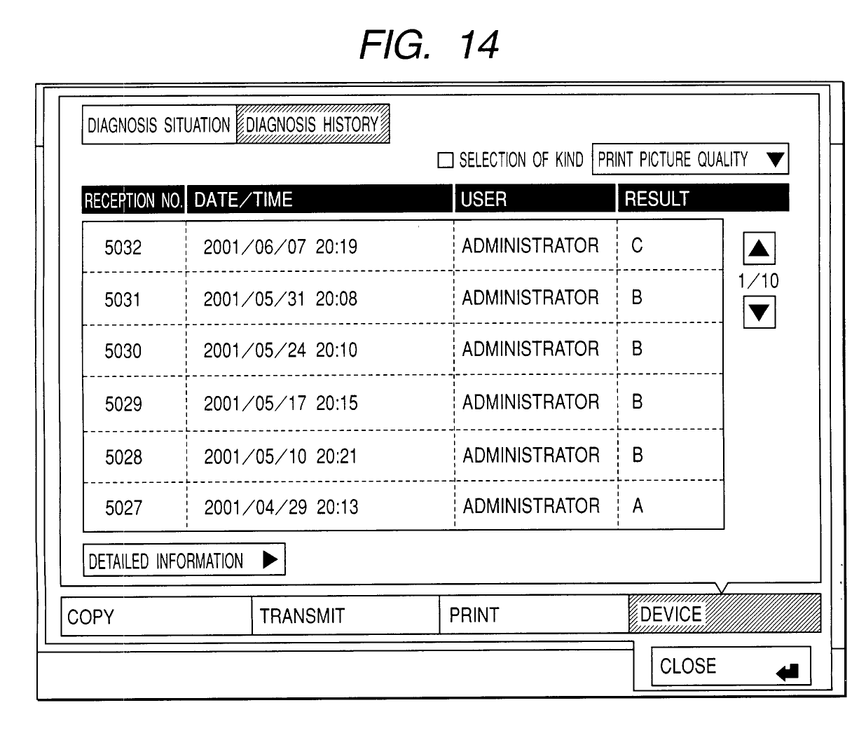

The user can confirm a history of the diagnosis by the operating unit 202 of the client apparatus or the display unit 105 of the scanner 104 for discrimination. FIG. 14 is a diagram showing a display example in the case where the history of the diagnosis is displayed to the operating unit 202 or the display unit 105. A displayed discrimination result has been stored in a discrimination result storing unit.

In FIG. 14, the operating unit 202 or the display unit 105 displays the date/time when the diagnosis has been performed in a list form, the user who performed the diagnosis, and the discrimination result every reception number which is issued each time the diagnosis is performed. If there are a plurality of printers, the apparatus kind number of the diagnosed printer can be also displayed. If information showing whether the discrimination result has been transmitted to the maintenance server 101 or not is displayed, it will be further useful for the user.

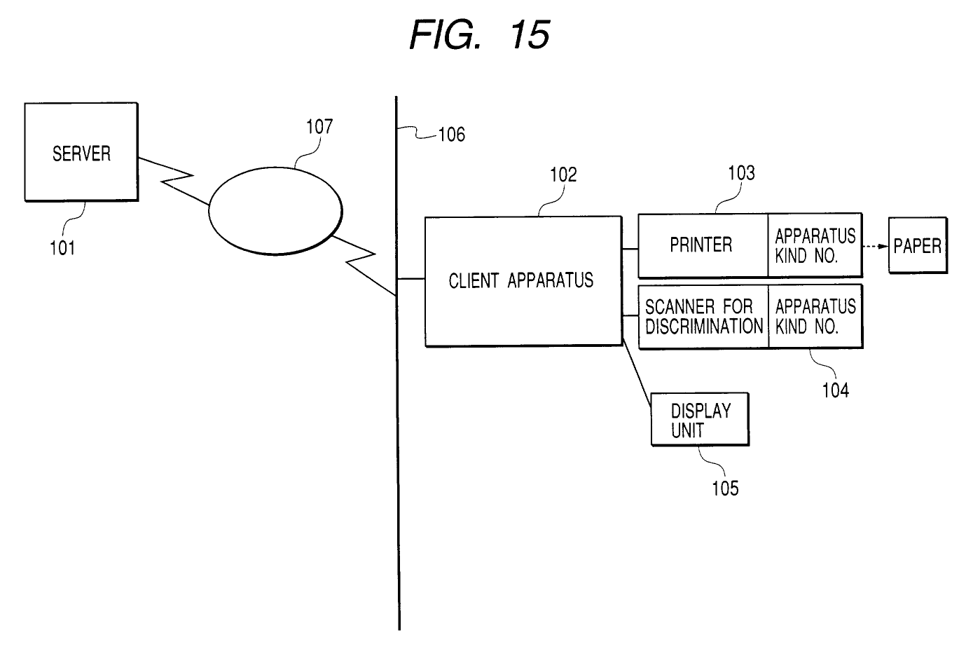

Although the client apparatus and the scanner 104 for discrimination have been separately provided in the above embodiment, they can be also integrated. FIG. 15 is a diagram showing a construction of a system in such a case. At this time, the scanner 201 is replaced by the scanner 104 for discrimination and the operating unit 202 is replaced by the display unit 105.

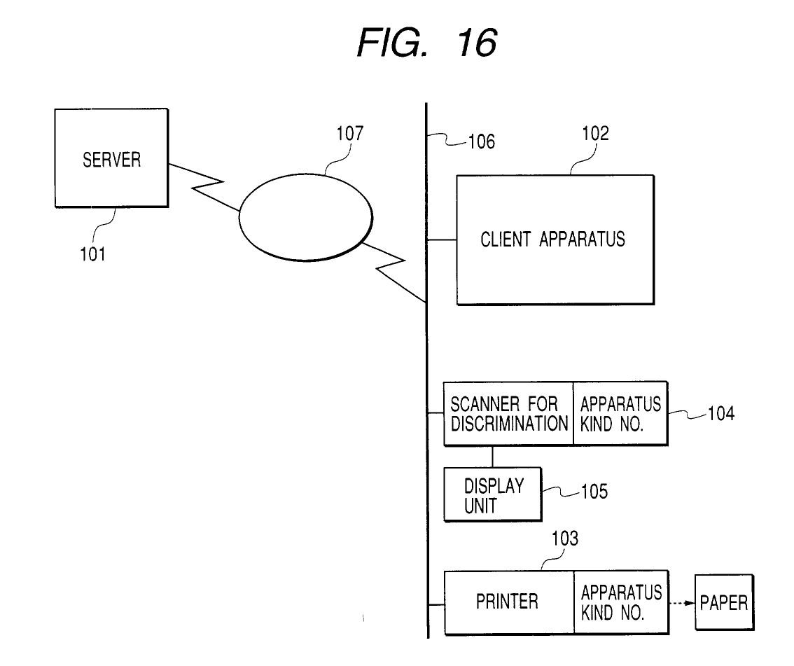

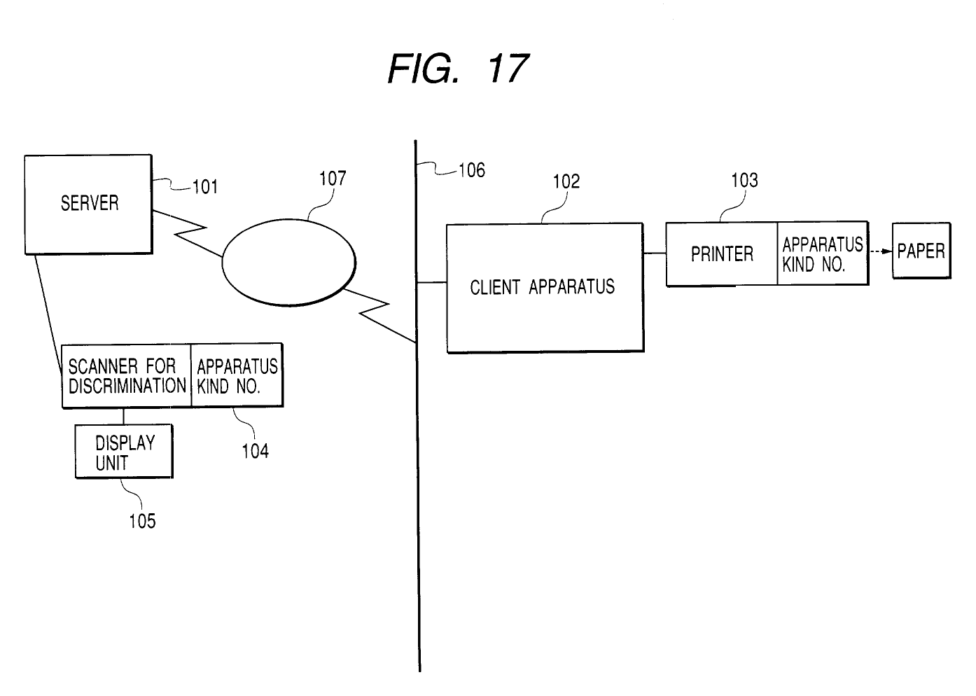

The client apparatus, printer, and scanner can be also separately provided. FIG. 16 is a diagram showing a construction of a system in such a case. The scanner for discrimination can be also connected to the maintenance server. At this time, the serviceman presses the diagnosis start key, brings back the printed matter outputted by the test print, and sets it into the scanner for discrimination. FIG. 17 is a diagram showing a construction of a system in such a case.

FIG. 18 is a diagram showing a memory map in a state where program codes have been loaded into the RAM of the maintenance server 101 and can be executed by the CPU of the maintenance server 101. Besides the program codes, a basic I/O program, an operating system such as a Windows system or the like, related data, a work area which is used when the CPU executes the program, and the like are also prepared on the RAM.

FIG. 19 is a diagram showing a memory map in a state where the program codes have been loaded into the RAM of the client apparatus 102 and can be executed by the CPU of the maintenance server 101. Besides the program codes, a basic I/O program, an operating system such as a Windows system or the like, related data, a work area which is used when the CPU executes the program, and the like are also prepared on the RAM.

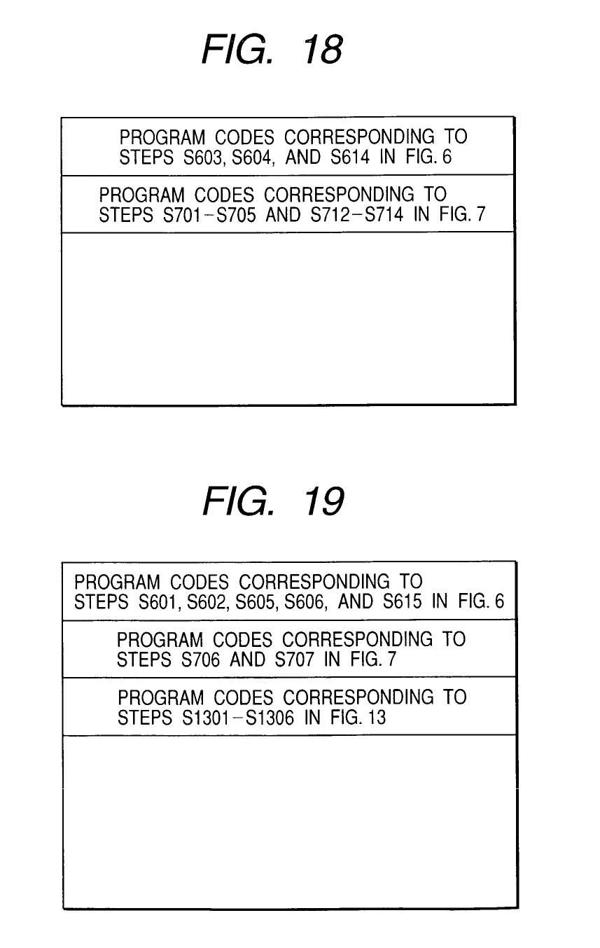

FIG. 20 is a diagram showing a memory map in a state where the program codes have been loaded into the RAM of the scanner 104 for discrimination and can be executed by the CPU of the scanner 104 for discrimination. Besides the program codes, a basic I/O program, an operating system such as a Windows system or the like, related data, a work area which is used when the CPU executes the program, and the like are also prepared on the RAM.

The program codes and the related data according to the invention are stored into a floppy disk (FD) or a CD-ROM and can be supplied therefrom to a computer. FIGS. 18 to 20 are also the diagrams each showing the memory map in a state where the program codes and the related data according to the invention have been stored into the FD or CD-ROM.

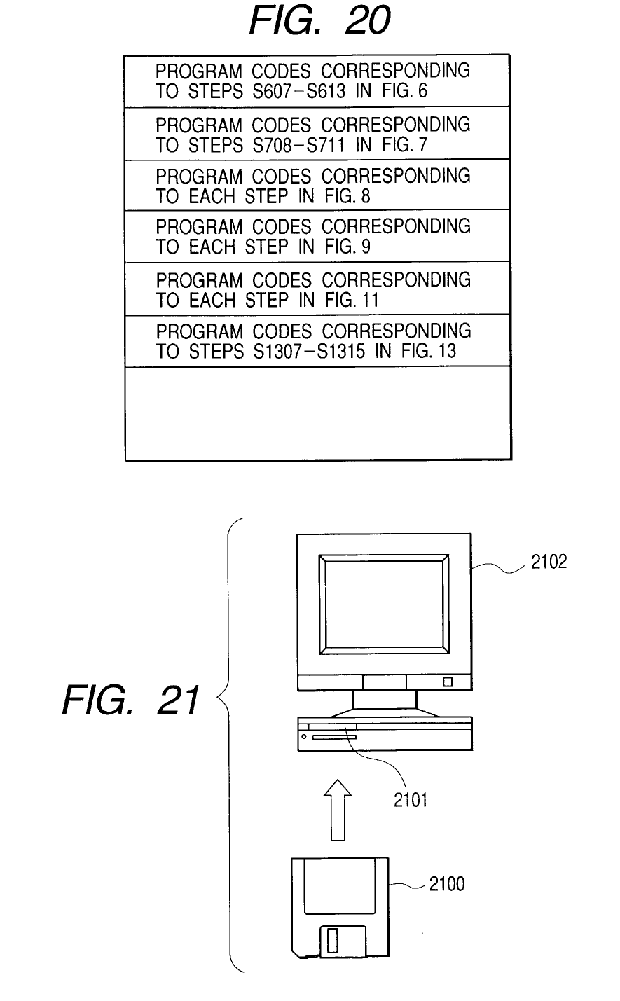

The objects of the invention are accomplished by a method whereby a memory medium in which the program codes of software (control program) for realizing the functions of the embodiments mentioned above have been recorded is supplied to a computer as shown in FIG. 21, and a control apparatus (CPU) of the computer reads out and executes the program codes stored in the memory medium. As a method of supplying the programs and data shown in FIGS. 18 to 20, a method whereby they are stored into a floppy disk FD 2100 and supplied therefrom to a computer main body 2102 (via a floppy disk drive 2101) as shown in FIG. 21 is generally used. In this case, the program codes themselves read out from the memory medium realize the functions of the embodiments mentioned above, and the memory medium in which the program codes have been stored constructs the invention.

As a memory medium for supplying the program codes, for example, besides the floppy disk or the hard disk, it is possible to use an optical disk, a magnetooptic disk, a CD-ROM, a CD-R, a magnetic tape, a nonvolatile memory card, an ROM, or the like. Naturally, the invention incorporates not only a case where the computer executes the read-out program codes, so that the functions of the embodiments mentioned above are realized but also a case where an OS (Operating System) or the like which is operating on the computer executes a part or all of actual processes on the basis of instructions of the program codes, and the functions of the embodiments mentioned above are realized by those processes. Further, naturally, the invention also incorporates a case where the program codes read out from the memory medium are written into a memory equipped for a function expanding board inserted into a computer or a function expanding unit connected to a computer and, thereafter, a CPU or the like provided for the function expanding board or function expanding unit executes a part or all of actual processes on the basis of instructions of the program codes, and the functions of the embodiments mentioned above are realized by those processes.

According to the invention, whether it is necessary to remotely diagnose the deterioration of the print picture quality which could not be detected by the image processing apparatus itself so far and perform the maintenance of the image processing apparatus or not can be monitored from a remote location. Thus, a situation such that in order to check the print picture quality, the serviceman goes to the installing location of the image processing apparatus can be reduced.

When the print picture quality is diagnosed, by successively displaying the guidance of the diagnosing process, the user other than the special serviceman can easily execute the diagnosing process. Further, the troublesomeness of the user can be reduced as much as possible and the print picture quality can be diagnosed.

By executing the test plural times in accordance with the discrimination result of the print picture quality, the discrimination can be made more accurately and in more detail. If there is a problem in the print picture quality, its causes can be presumed.

By discriminating the print picture quality with reference to the print conditions set by the user, the maintenance service can be provided so that the printer can execute the printing which satisfies the desired conditions of the user.

By switching the counters for counting the number of print sheets in accordance with the discrimination result showing that there is a problem in the print picture quality, a process such that the copy or printing request is perfectly inhibited because there is a problem in the print picture quality is not executed, but it is possible to construct the system in a manner such that the copy or printing request which is executed during a period of time when there is a problem in the print picture quality is charged at low costs.

What is claimed is:

1. A diagnosing method of diagnosing print picture quality of an image processing apparatus, comprising:
a transfer step of transferring test data which is necessary for a test print from an external apparatus to said image processing apparatus;
an image input step of scanning an image which was print-outputted by said image processing apparatus in accordance with the test data and inputting image data;
a discriminating step of examining the image data and discriminating the print picture quality of the image processing apparatus; and
a notifying step of controlling whether the external apparatus is notified of a discrimination result in said discriminating step or not in accordance with said discrimination result.

2. A method according to claim 1, wherein in said notifying step, whether the external apparatus is notified of the discrimination result or not is discriminated in accordance with contents of a contract of maintenance.

3. A method according to claim 1, wherein in said notifying step,
if the discrimination result is at a predetermined level, the external apparatus is notified of said discrimination result, and
if the discrimination result is not at the predetermined level, said discrimination result is stored and the external apparatus is notified of a plurality of discrimination results in the lump.

4. A method according to claim 1, wherein in said transfer step, said test data is transferred in accordance with a depression of a button showing an instruction of the diagnosis.

5. A method according to claim 1, further comprising:
a use discriminating step of discriminating whether the test data in the external apparatus is used or the test data in said image processing apparatus is used; and
an execution instructing step of issuing an instruction to use the test data in said image processing apparatus to the image processing apparatus on the basis of a result of the discrimination in said use discriminating step.

6. A method according to claim 1, further comprising:
a first counting step of counting the number of print sheets or the number of printing times;
a second counting step of counting the number of print sheets or the number of printing times; and
a count switching step of switching from said first counting step to said second counting step in accordance with that the discrimination result in said discriminating step is at a predetermined level, thereby allowing the number of print sheets or the number of printing times of the image processing apparatus to be counted.

7. A method according to claim 1, further comprising:
a holding step of holding the discrimination result in said discriminating step; and
a history displaying step of displaying a history of the discrimination results held by said holding step.

8. A method according to claim 7, wherein in said history displaying step, at least one of a number issued for the discrimination, date/time when the discrimination has been performed, the discrimination result, and the presence or absence of the notification to the external apparatus is displayed.

9. A method according to claim 1, further comprising a message displaying step of displaying a message showing that the test data has been received in accordance with that the test data is transferred from the external apparatus.

10. A method according to claim 1, further comprising a message displaying step of displaying a message showing that paper is set into said image input step in accordance with a completion of the printing according to the test data.

11. A system for diagnosing print picture quality of an image processing apparatus, comprising:
transfer means for transferring test data which is necessary for a test print from an external apparatus to said image processing apparatus;
image input means for scanning an image which was print-outputted by said image processing apparatus in accordance with the test data and inputting image data;
discriminating means for examining the image data and discriminating the print picture quality of the image processing apparatus; and
notifying means for controlling whether the external apparatus is notified of a discrimination result in said discriminating means or not in accordance with said discrimination result.

12. An image processing apparatus for diagnosing print picture quality of a printer unit, comprising:
receiving means for receiving test data necessary for a test print from an external apparatus;
image input means for scanning an image which was print-outputted by said printer unit in accordance with the test data and inputting image data;
discriminating means for examining the image data and discriminating the print picture quality of the printer unit; and
notifying means for controlling whether the external apparatus is notified of a discrimination result in said discriminating means or not in accordance with said discrimination result.

13. A method of switching counters for counting the number of print sheets or the number of printing times in an image processing apparatus, comprising:
a discriminating step of discriminating a status of said image processing apparatus; and
a count switching step of switching from a first counter to a second counter on the basis of a discrimination result in said discriminating step, thereby allowing the number of print sheets or the number of printing times in the image processing apparatus to be counted.

14. A method according to claim 13, wherein
in said discriminating step, print picture quality in said image processing apparatus is discriminated, and
in said count switching step, said first counter is switched to said second counter in accordance with that the print picture quality is equal to or less than a predetermined level.

15. An image processing apparatus having counters for counting the number of print sheets or the number of printing times, comprising:
discriminating means for discriminating a status of said image processing apparatus; and
count switching means for switching from a first counter to a second counter on the basis of a discrimination result in said discriminating means, thereby allowing the number of print sheets or the number of printing times in the image processing apparatus to be counted.

16. An apparatus according to claim 15, wherein
said discriminating means discriminates print picture quality in said image processing apparatus, and
said count switching means switches said first counter to said second counter in accordance with that the print picture quality is equal to or less than a predetermined level.
